(19) United States
(12) Patent Application Publication
(10) Pub. No.: US 2022/0182933 A1
(43) Pub. Date: Jun. 9, 2022

(54) METHOD AND APPARATUS FOR SIGNAL TRANSMISSION AND RECEPTION IN WIRELESS COMMUNICATION SYSTEM

(71) Applicant: POSTECH Research and Business Development Foundation, Pohang-si (KR)

(72) Inventors: Jae Hyeon PARK, Gangneung-si (KR); Young Deok PARK, Incheon (KR); Young Joo SUH, Pohang-si (KR)

(21) Appl. No.: 17/542,301

(22) Filed: Feb. 24, 2022

(30) Foreign Application Priority Data
Dec. 4, 2020 (KR) 10-2020-0168135
Dec. 3, 2021 (KR) 10-2021-0172426

(51) Int. Cl. H04W 52/02; H04L 27/26

(52) U.S. Cl. CPC H04W 52/0225; H04L 27/2601

(57) ABSTRACT

An operation method of a first communication node in a communication system, according to an exemplary embodiment of the present disclosure for achieving the above-described objective, may comprise: transitioning to a down-clocking state; performing a monitoring operation in the down-clocking state; detecting reception of a first packet transmitted from a second communication node providing a service to the first communication node; identifying a first preamble included in the first packet; performing analysis on the first preamble; and based on a result of the analysis on the first preamble, determining whether to maintain the down-clocking state or transition to a full-clocking state.

### CROSS-REFERENCE TO RELATED APPLICATIONS

This application claims priority to Korean Patent Applications No. 10-2020-0168135, filed on Dec. 4, 2020, and No. 10-2021-0172426 filed on Dec. 3, 2021 with the Korean Intellectual Property Office (KIPO), the entire contents of which are hereby incorporated by reference.

### BACKGROUND

### 1. Technical Field

The present disclosure relates to techniques for transmitting and receiving signals in a wireless communication system, and more particularly, to signal transmission and reception techniques for reducing power consumption of a terminal performing communications in a wireless communication system.

### 2. Related Art

With the development of information and communication technology, various wireless communication technologies are being developed. The wireless communication technology is largely classified into a wireless communication technology that uses a licensed band, and a wireless communication technology that uses an unlicensed band (e.g., industrial scientific medical (ISM) band) according to a band used. Since a right to use a licensed band is exclusively given to one operator, the wireless communication technology using the licensed band may provide better reliability and communication quality compared to the wireless communication technology using an unlicensed band.

Representative wireless communication technologies using a licensed band include long term evolution (LTE) and new radio (NR) defined by the 3rd generation partnership project (3GPP). The LTE may be one of 4^{th} generation (4G) wireless communication technologies, and the NR may be one of 5^{th} generation (5G) wireless communication technologies. Each of a base station and a user equipment (UE) supporting cellular communications such as the 4G LTE or 5G NR may transmit and receive signals through a licensed band. On the other hand, as representative wireless communication technologies using an unlicensed band, there is a wireless local area network (WLAN) defined by the IEEE 802.11. Each of an access point (AP) and a station supporting the WLAN may transmit and receive signals through an unlicensed band.

In general, since a mobile terminal is supplied with power through a battery, it is an important issue to minimize power consumption in order to increase the operating time of the terminal. In an exemplary embodiment of the communication system, the terminal normally waits in a sleep state to save power, and when it has a packet to transmit or should receive a beacon packet periodically transmitted by an AP, it may transition to an awake state. A monitoring operation in the awake state may cause power consumption. In this reason, a technique for reducing power consumption of operations of the terminal for communications with the AP may be required.

Matters described in the related art are prepared to enhance understanding of the background of the present disclosure, and may include matters that are not already known to those of ordinary skill in the art to which this technology belongs.

### SUMMARY

Accordingly, exemplary embodiments of the present disclosure are directed to providing signal transmission and reception methods and apparatuses for reducing power consumption of a monitoring operation performed for communications between a terminal and an access point (AP).

An operation method of a first communication node in a communication system, according to an exemplary embodiment of the present disclosure for achieving the above-described objective, may comprise: transitioning to a down-clocking state; performing a monitoring operation in the down-clocking state; detecting reception of a first packet transmitted from a second communication node providing a service to the first communication node; identifying a first preamble included in the first packet; performing analysis on the first preamble; and based on a result of the analysis on the first preamble, determining whether to maintain the down-clocking state or transition to a full-clocking state.

The first preamble may have a structure including two identical orthogonal frequency division multiplexing (OFDM) symbols each of which is mapped to address information corresponding to the first communication node.

The monitoring operation may correspond to a carrier sensing operation, and the performing of the analysis may comprise: detecting carrier energy level values of the first preamble including the two identical OFDM symbols in each of two separate time windows; calculating an auto-correlation value between energy level values detected in the two separate time windows; comparing the calculated autocorrelation value with a first threshold; and in response to determining that the calculated autocorrelation value is greater than the first threshold, determining to perform device address recognition (DAR) for the first preamble.

The monitoring operation may correspond to a carrier sensing operation, and the performing of the analysis may comprise: detecting carrier energy level values of the first preamble including the two identical OFDM symbols in each of two separate time windows; calculating an auto-correlation value between energy level values detected in the two separate time windows; comparing the calculated autocorrelation value with a first threshold; and in response to determining that the calculated autocorrelation value is less than or equal to the first threshold, determining to maintain the down-clocking state.

The performing of the analysis on the first preamble may comprise: obtaining a device address value mapped to the first preamble through device address recognition for the first preamble; and comparing the obtained device address value with a first address value that is an address of the first communication node.

The obtaining of the device address value mapped to the first preamble may comprise: identifying energy levels of a plurality of subcarriers constituting one or more OFDM symbols constituting the first preamble; and identifying information on the device address value based on the identified energy levels of the plurality of subcarriers.

The determining whether to maintain the down-clocking state or transition to the full-clocking state may comprise: in response to determining that the obtained device address value does not match the first address value, determining to maintain the down-clocking state.

The determining whether to maintain the down-clocking state or transition to the full-clocking state may comprise: in response to determining that the obtained device address value matches the first address value, determining to transition to the full-locking state.

The operation method may further comprise, after determining to transition to the full-clocking state, receiving data included in the first packet transmitted from the second communication node in the full-clocking state; and when the reception of the data included in the first packet is completed, transitioning to the down-clocking state.

The operation method may further comprise, before transitioning to the down-clocking state, performing iterative learning a plurality of times based on results of receiving a plurality of OFDM symbols transmitted from the second communication node, through a predetermined machine learning structure; and generating a first computational model, the first computational mode using the results of receiving the plurality of OFDM symbols as input values and using an estimated value of a device address mapped to the plurality of OFDM symbols as an output value.

The predetermined machine learning structure may include a deep neural network (DNN) configured to include a plurality of hidden layers, and the iterative learning may be performed based on a DNN scheme.

The predetermined machine learning structure may include a first artificial neural network, a second artificial neural network, and a third artificial neural network, and the iterative learning may be performed based on a recurrent neural network (RNN) scheme.

The performing of the analysis on the first preamble may comprise obtaining a device address value mapped to the first preamble through device address recognition for the first preamble, and the obtaining of the device address value mapped to the first preamble is performed based on the first computational model.

A first communication node in a communication system, according to an exemplary embodiment of the present disclosure for achieving the above-described objective, may comprise: a processor; a memory electronically communicating with the processor; and instructions stored in the memory, wherein when executed by the processor, the instructions cause the first communication node to: transition to a down-clocking state; perform a monitoring operation in the down-clocking state; detect reception of a first packet transmitted from a second communication node providing a service to the first communication node; identify a first preamble included in the first packet; perform analysis on the first preamble; and based on a result of the analysis on the first preamble, determine whether to maintain the down-clocking state or transition to a full-clocking state.

The first preamble may have a structure including two identical orthogonal frequency division multiplexing (OFDM) symbols each of which is mapped to address information corresponding to the first communication node, the monitoring operation may correspond to a carrier sensing operation, and the instructions may further cause the first communication node to: detect carrier energy level values of the first preamble including the two identical OFDM symbols in each of two separate time windows; calculate an auto-correlation value between energy level values detected in the two separate time windows; compare the calculated autocorrelation value with a first threshold; in response to determining that the calculated autocorrelation value is greater than the first threshold, determine to perform device address recognition (DAR) for the first preamble; and in response to determining that the calculated autocorrelation value is less than or equal to the first threshold, determine to maintain the down-clocking state.

The instructions may further cause the first communication node to: obtain a device address value mapped to the first preamble through device address recognition for the first preamble; and compare he obtained device address value with a first address value that is an address of the first communication node.

The instructions may further cause the first communication node to: identify energy levels of a plurality of subcarriers constituting one or more OFDM symbols constituting the first preamble; and identify information on the device address value based on the identified energy levels of the plurality of subcarriers.

The instructions may further cause the first communication node to: in response to determining that the obtained device address value does not match the first address value, determine to maintain the down-clocking state; and in response to determining that the obtained device address value matches the first address value, determine to transition to the full-locking state.

The instructions may further cause the first communication node to, before transitioning to the down-clocking state, perform iterative learning a plurality of times based on results of receiving a plurality of OFDM symbols transmitted from the second communication node, through a predetermined machine learning structure; and generate a first computational model, the first computational mode using the results of receiving the plurality of OFDM symbols as input values and using an estimated value of a device address mapped to the plurality of OFDM symbols as an output value.

The predetermined machine learning structure may include a first artificial neural network, a second artificial neural network, and a third artificial neural network, the iterative learning may be performed based on a recurrent neural network (RNN) scheme, and the instructions may further cause the first communication node to perform device address recognition for the first preamble based on the first computational model.

According to an exemplary embodiment of the present disclosure, in a power saving mode, a terminal using a wireless LAN may perform monitoring in a down-clocking state during an idle listening time. Accordingly, power consumption occurring while the terminal performs monitoring during the idle listening time can be reduced. An AP may configure a packet to be transmitted to the terminal based on predetermined orthogonal frequency division multiplexing (OFDM) symbols to which an address of the terminal is mapped. The terminal may determine whether to maintain the down-clocking state or transition to a full-clocking state based on the OFDM symbols transmitted from the AP. Accordingly, the power consumption of the terminal using the wireless LAN can be reduced, and a network throughput can be improved.

### BRIEF DESCRIPTION OF DRAWINGS

FIG. 1 is a conceptual diagram illustrating a first exemplary embodiment of a communication system.

FIG. 2 is a conceptual diagram illustrating an exemplary embodiment of a communication node constituting a communication system.

FIG. 3 is a conceptual diagram illustrating a second exemplary embodiment of a communication system.

FIGS. 4A and 4B are conceptual diagrams for describing an exemplary embodiment of a packet reception method to which down-clocking is applied.

FIG. 5 is a sequence chart illustrating an exemplary embodiment of a signal transmission and reception method in a communication system.

FIG. 6 is a flowchart for describing an exemplary embodiment of a method for determining whether to transition to the full-clocking state in a communication system.

FIG. 7 is a conceptual diagram illustrating a first exemplary embodiment of a machine learning structure used for device address recognition (DAR) in a communication system.

FIGS. 8A to 8C are conceptual diagrams for describing a second exemplary embodiment of a machine learning structure used for DAR in a communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Throughout the present disclosure, a ‘network’ may include, for example, a wireless Internet such as wireless fidelity (Wi-Fi), a portable Internet such as wireless broadband internet (WiBro) or world interoperability for microwave access (WiMax), a 2^{nd} generation (2G) mobile communication network such as global system for mobile communication (GSM) or code division multiple access (CDMA), a 3^{rd} generation (3G) mobile communication network such as wideband code division multiple access (WCDMA) or CDMA 2000, a 3.5^{th} generation (3.5G) mobile communication network such as high speed downlink packet access (HSDPA) or high speed uplink packet access (HSUPA), a 4^{th} generation (4G) mobile communication network such as long term evolution (LTE) or LTE-Advanced, a 5th generation (5G) mobile communication network, and/or the like.

Throughout the present disclosure, a station (STA) may mean a functional entity including a medium access control (MAC) conforming to the Institute of Electrical and Electronics Engineers (IEEE) 802.11 standard and a physical layer interface for a wireless medium. The STA may be classified into a STA that is an access point (AP) and a STA that is a non-access point (non-AP) STA. The STA that is an AP may simply be referred to as an AP, and the STA that is a non-AP STA may simply be referred to as a terminal.

The STA may include a processor and a transceiver, and may further include a user interface and a display device. The processor means a unit designed to generate a frame to be transmitted through a wireless network or process a frame received through the wireless network, and may perform various functions for controlling the STA. The transceiver is functionally connected to the processor and refers to a unit designed to transmit and receive frames for the STA through the wireless network.

The AP may refer to a centralized controller, a base station (BS), a radio access station, a node B (NB), an evolved node B (eNB), a relay, a mobile multihop relay (MMR)-BS, a base transceiver system (BTS), a site controller, or the like, and may include some or all of functions thereof.

The terminal (i.e., non-AP STA) may refer to a wireless transmit/receive unit (WTRU), a user equipment (UE), a user terminal (UT), an access terminal (AT), a mobile station (MS), a mobile terminal, a subscriber unit, a subscriber station (SS), a wireless device, or a mobile subscriber unit, or the like, and may include some or all of functions thereof.

Here, the terminal may be a desktop computer, a laptop computer, a tablet PC, a wireless phone, a mobile phone, a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, or the like which has communication capability.

Hereinafter, preferred exemplary embodiments of the present disclosure will be described in more detail with reference to the accompanying drawings. In describing the present disclosure, in order to facilitate the overall understanding, the same reference numerals are used for the same components in the drawings, and duplicate descriptions of the same components are omitted.

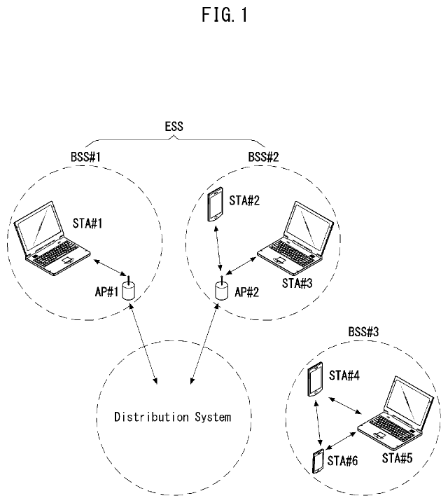

FIG. 1 is a conceptual diagram illustrating a first exemplary embodiment of a communication system.

Referring to FIG. 1, a communication system may correspond to a wireless local area network (WLAN) communication system. For example, the communication system may be a communication system (e.g., WLAN-based communication system) conforming to the IEEE 802.11 standard. The WLAN communication system may be referred to as a wireless LAN communication system or a Wireless Fidelity (Wi-Fi) communication system. In the wireless LAN communication system, a STA may refer to a communication node performing functions of a MAC layer defined in the IEEE 802.11 standard and functions of a physical layer for a wireless medium. The STA may be classified into an AP STA and a non-AP STA. The AP STA may simply be referred to as an AP, and the non-AP STA may simply be referred to as a STA. In addition, an AP may be referred to as a base station (BS), a node B (NB), an evolved node B (eNB), a relay, a radio remote head (RRH), a transmission and reception point (TRP), or the like. The STA may be referred to as a terminal, a wireless transmit/receive unit (WTRU), user equipment (UE), a device, or the like, and may be a smart phone, a tablet PC, a laptop computer, a sensor device, or the like.

The wireless LAN system may include at least one basic service set (BSS). The BSS denotes a set of stations (STAs) (e.g., STA #1, AP #1, STA #2, AP #2, STA #3, STA #4, STA #5, STA #6) configured to communicate with each other through successful synchronization. The BSS does not necessarily denote a specific area. In exemplary embodiments below, a STA that performs functions of an AP may be referred to as an ‘AP’, and a STA that does not perform functions of an AP may be referred to as a ‘non-AP STA’ or ‘STA’.

The BSSs may be classified as infrastructure BSSs and independent BSSs (IBSSs). In particular, a BSS #1 and a BSS #2 may be infrastructure BSSs, and a BSS #3 may be an IBSS. The BSS #1 may include a first STA (STA #1), a first AP (AP #1) providing a distribution service, and a distribution system (DS) connecting a plurality of APs (e.g., AP #1 and AP #2). In the BSS #1, the AP #1 may manage the STA #1.

The BSS #2 includes a third station (STA #3), a fourth station (STA #4), a second AP (AP #2) providing a distribution service, and a DS connecting a plurality of APs (e.g., AP #1 and AP #2). In the BSS #2, the AP #2 may manage the STA #3 and the STA #4.

The BSS #3 may mean an IBSS operating in an ad-hoc mode. An AP, which is a centralized management entity, may not exist in the BSS #3. That is, in the BSS #3, the STA #4, STA #5, and STA #6 may be managed in a distributed manner. In the BSS #3, all the STAs STA #4, STA #5, and STA #6 may mean mobile stations, and since access through a DS is not allowed, they form a self-contained network.

The APs (i.e., AP #1 and AP #2) may provide access to the DS via a wireless medium for the STA #1, STA #2, and STA #3 associated therewith. In the BSS #1 or BSS #2, communication between the STA #1, STA #2, and STA #3 is generally performed through the AP (i.e., AP #1 and AP #2), but when a direct link is established, direct communications between the STA #1, STA #2, and STA #3 is possible.

A plurality of infrastructure BSSs may be interconnected via a DS. A plurality of BSSs connected via a DS is referred to as an extended service set (ESS). The stations (e.g., STA #1, AP #1, STA #2, STA #3, AP #2) included in an ESS may be configured to communicate with each other, and a station (e.g., STA #1, STA #2, or STA #3) in the ESS may move from one BSS to another BSS while performing seamless communication.

The DS is a mechanism for one AP to communicate with another AP. Using the DS, an AP may transmit frames to STAs belonging to a BSS it manages, or may transmit frames to a STA moved to another BSS. In addition, the AP may transmit and receive frames to and from an external network such as a wired network. Such the DS does not necessarily have to be a network, and if it can provide a predetermined distribution service stipulated in the IEEE 802.11 standard, there is no restriction on its form. For example, the DS may be a wireless network such as a mesh network or a physical structure that connects APs to each other.

The exemplary embodiment of the communication system described with reference to FIG. 1 is merely an example for convenience of description, and exemplary embodiments of the present disclosure are not limited thereto. For example, exemplary embodiments of the present disclosure may be applied to a portable Internet such as wireless personal area network (WPAN), wireless body area network (WBAN), wireless broadband internet (WiBro), or world interoperability for microwave access (WiMax), a 2G mobile communication network such as global system for mobile communication (GSM) or code division multiple access (CDMA), a 3G mobile communication network such as wideband code division multiple access (WCDMA) or cdma2000, a 3.5G mobile communication network such as high speed downlink packet access (HSDPA) or high speed uplink packet access (HSUPA), a 4G mobile communication network such as long term evolution (LTE) or a LTE-Advanced, a 5G mobile communication network, a 6G mobile communication network, and/or the like.

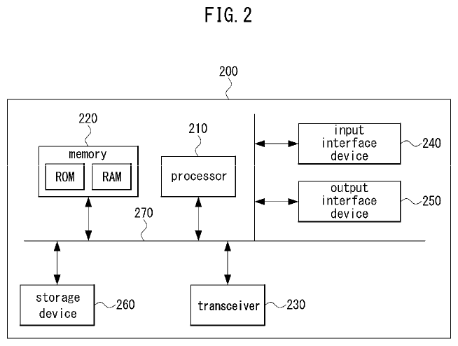

FIG. 2 is a conceptual diagram illustrating an exemplary embodiment of a communication node constituting a communication system.

Referring to FIG. 2, a communication node 200 may comprise at least one processor 210, a memory 220, and a transceiver 230 connected to a network for performing communications. Also, the communication node 200 may further comprise an input interface device 240, an output interface device 250, a storage device 260, and the like. Each component included in the communication node 200 may communicate with each other as connected through a bus 270.

However, each of the components included in the communication node 200 may be connected to the processor 210 via a separate interface or a separate bus rather than the common bus 270. For example, the processor 210 may be connected to at least one of the memory 220, the transceiver 230, the input interface device 240, the output interface device 250, and the storage device 260 via a dedicated interface.

The processor 210 may execute at least one instruction stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may include at least one of a volatile storage medium and a non-volatile storage medium. For example, the memory 220 may comprise at least one of read-only memory (ROM) and random access memory (RAM).

Hereinafter, signal transmission and reception methods in a wireless communication system will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. For example, when an operation of a receiving node is described, a transmitting node corresponding thereto may perform an operation corresponding to the operation of the receiving node. Conversely, when an operation of a transmitting node is described, a receiving node corresponding thereto may perform an operation corresponding to the operation of the transmitting node.

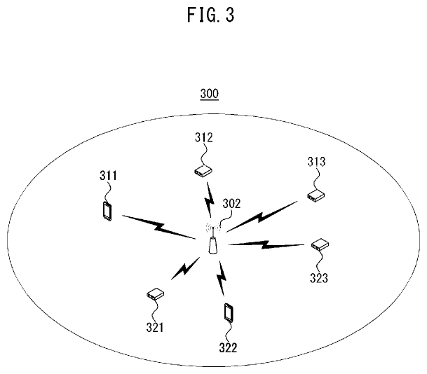

FIG. 3 is a conceptual diagram illustrating a second exemplary embodiment of a communication system.

Referring to FIG. 3, a communication system 300 may include at least one AP and one or more terminals. The communication system 300 may be a wireless LAN communication system. The at least one AP may form a coverage within a predetermined communicable range. One or more terminals belonging to the coverage of the at least one AP may receive a service from the AP forming the coverage to which they belong. FIG. 3 shows an exemplary embodiment in which the communication system 300 includes one AP 302 and a plurality of terminals 311, 312, 313, 321, 322, and 323. However, this is only an example for convenience of description, and exemplary embodiments of the present disclosure are not limited thereto.

The AP 302 may support a communication protocol used by each of the terminals 311, 312, 313, 321, 322, and 323. One or more of the terminals 311, 312, 313, 321, 322, and 323 may use a communication protocol specified in the IEEE 802.11 standard. One or more of the terminals 311, 312, 313, 321, 322, and 323 may use a communication protocol specified in the IEEE 802.11a/b/g/n/ab/ac/ax/ad/ay, or the like.

In order for the terminals 311, 312, 313, 321, 322, and 323 to receive a signal from the AP 302, it may be required to monitor a signal transmitted from the AP 302. Continuous monitoring may increase power consumption of the terminals 311, 312, 313, 321, 322, and 323. Accordingly, each of the terminals 311, 312, 313, 321, 322, and 323 may perform operations for reducing power consumption due to the monitoring.

For example, among the terminals 311, 312, 313, 321, 322, and 323, the first to third terminals 311, 312, and 313 may perform operations according to a power saving mode. The first to third terminals 311, 312, and 313 operating in the power saving mode may reduce power consumption by periodically switching from a low power sleep state to an awake state.

Specifically, the first to third terminals 311, 312, and 313 using the power saving mode may stand by in the sleep state basically or in normal times. The first to third terminals 311, 312, and 313 may transition to the awake state when there is a packet to be transmitted or when they want to receive a packet such as a beacon packet periodically transmitted from the AP 302. Upon receiving a beacon packet transmitted from the AP 302, in order to identify whether a packet to be transmitted by the AP 302 is buffered, the first to third terminals 311, 312, and 313 may identify a traffic indication map (TIM) field within the received beacon packet.

If there is no packet to be received, the first to third terminals 311, 312, and 313 may transition to the sleep state. Here, in order to reduce a transmission latency, the first to third terminals 311, 312, and 313 may wait for a predetermined time to monitor whether there is an additionally received packet, and then transition to the sleep state.

On the other hand, if there is a packet to be received from the AP 302, the first to third terminals 311, 312, and 313 may receive the packet transmitted from the AP 302. When packet transmission and reception is completed, the first to third terminals 311, 312, and 313 may transition to the sleep state. Here, in order to reduce a transmission latency, the first to third terminals 311, 312, and 313 may wait for a predetermined time to monitor whether there is an additionally received packet, and then transition to the sleep state.

As described above, the waiting time after the terminal in the power saving mode transitions from the sleep state to the awake state to reduce a transmission latency even after completing packet transmission and reception may be referred to as an ‘idle listening time’ or a ‘idle listening period’. The idle listening time may have an effect of reducing a transmission latency. Meanwhile, since the first to third terminals 311, 312, and 313 continuously perform monitoring during the idle listening time, there may be a problem that power consumption thereof may continue to occur. A technique to reduce such the power consumption may be required.

Meanwhile, among the terminals 311, 312, 313, 321, 322, and 323, the fourth to sixth terminals 321, 322, and 323 may perform operations according to the power saving mode. The fourth to sixth terminals 321, 322, and 323 operating in the power saving mode may periodically transition from the low power sleep state to the awake state. Here, the fourth to sixth terminals 321, 322, 323 may be configured to operate in a ‘down-clocking state’ in which their clock speed is lowered during the idle listening time before transitioning back to the sleep state from the awake state. In the down-clocking state, the clock or the speed of the clock for operations of the terminal may be lowered. In other words, in the down-clocking state, a ‘tick’ may occur slowly in the clock for operations of the terminal. Through this, the fourth to sixth terminals 321, 322, and 323 may minimize the amount of power consumed or wasted during the idle listening time for reducing a transmission latency.

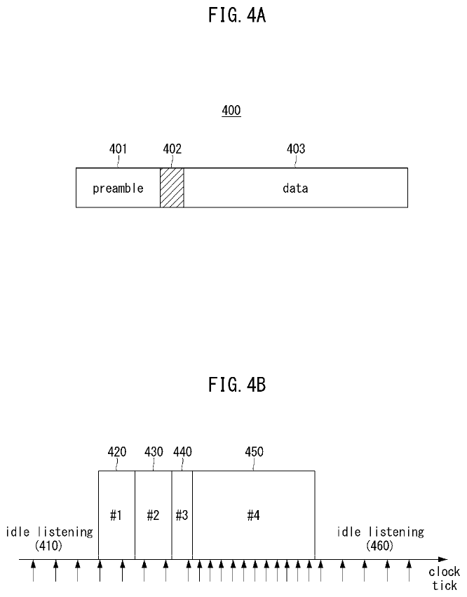

FIGS. 4A and 4B are conceptual diagrams for describing an exemplary embodiment of a packet reception method to which down-clocking is applied.

Referring to FIGS. 4A and 4B, a communication system may include a first communication node and a second communication node. Here, the first communication node may be the same as or similar to any one of the terminals 311, 312, 313, 321, 322, and 323 described with reference to FIG. 3. The second communication node may be the same as or similar to the AP 302 described with reference to FIG. 3. FIGS. 4A and 4B show an exemplary embodiment in which the first communication node corresponding to a terminal operates to monitor a packet transmitted from the second communication node corresponding to an AP in the communication system. However, this is only an example for convenience of description, and exemplary embodiments of the present disclosure are not limited thereto. The second communication node may be associated with the first communication node and other terminals (not shown) to provide services. Hereinafter, in describing an exemplary embodiment of a packet reception method to which down-clocking is applied with reference to FIGS. 4A and 4B, content overlapping with those described with reference to FIGS. 1 to 3 may be omitted.

Referring to FIG. 4A, when there is data to be transmitted to a terminal such as the first communication node, the second communication node may generate a packet 400 including the data. Here, the packet 400 may include at least one preamble 401 and a payload 403. The preamble 401 of the packet 400 may include control information to be referenced by a receiving node in the signal transmission/reception process. Meanwhile, the payload 403 may include the data to be transmitted by the second communication node.

The preamble 401 and the payload 403 may be consecutive in the time domain, and transmitted as one packet. Alternatively, the preamble 401 and the payload 403 may be transmitted spaced apart by a predetermined time interval 402 in the time domain. Alternatively, the preamble 401 may include a padding region having a length corresponding to the predetermined time interval 402. The preamble 401 including the padding region and the payload 403 may be consecutive in the time domain, and transmitted as one packet.

The preamble 401 may be referred to as a ‘header preamble’. The preamble may be transmitted once or may be transmitted repeatedly a plurality of times. The packet 400 may include only one preamble 401 or a plurality of preambles. In general, when the packet 400 transmitted from the AP or the like may include a plurality of preambles, it may be easy for a receiving terminal or the like to obtain information included in the preambles. However, when the packet 400 includes a plurality of preambles, an overhead may be excessively generated due to the plurality of preambles, and communication efficiency in the network may be deteriorated.

Meanwhile, in an exemplary embodiment of the communication system, the packet 400 may be configured to include only one preamble 401. Here, the preamble 401 may be configured to include a target address or a destination address of the packet 400. Here, the target address or destination address included in the preamble 401 may correspond to an address of a communication node to which the packet 400 is to be transmitted.

In an exemplary embodiment of the communication system, when establishing an association with each terminal, the second communication node may designate an arbitrary terminal address to the terminal, and store the designated terminal address in an address table. The terminal address may be an arbitrary address value having a length of 8 bits. However, this is only an example for convenience of description, and exemplary embodiments of the present disclosure are not limited thereto.

When the second communication node receives information such as data to be transmitted to another communication node from a connected communication network or backbone network, the second communication node may generate the packet 400 including the information to be transmitted. Here, the second communication node may configure the preamble 401 of the packet 400 to include information on an address of the communication node that will receive the data. For example, the second communication node may map the address of the terminal to which the data is to be transmitted to the preamble 401. Specifically, the second communication node may convert the terminal address of the terminal to which the data is to be transmitted into a binary value. The second communication node may map the converted terminal address to subcarriers of an orthogonal frequency division multiplexing (OFDM) symbol. The second communication node may duplicate the OFDM symbol to which the terminal address is mapped into two OFDM symbols. The second communication node may configure the preamble 401 by concatenating two identical duplicated symbols. Alternatively, the second communication node may configure the preamble 401 to include two identical symbols concatenated with each other. As such, the second communication node may configure the packet 400 including the preamble 401 configured through concatenation or combining of two OFDM symbols instead of configuring the packet 400 including a plurality of preambles. Accordingly, overhead due to the preamble during packet transmission may be reduced, and communication efficiency in the network may be improved. In addition, the preamble configured through concatenation or combining of two OFDM symbols may have an advantage that the receiving node can easily recover it.

During the idle listening time according to the power saving mode, the first communication node may operate in the down-clocking state. When the first communication node receives the packet 400 or the preamble 401 transmitted from the second communication node, it may determine whether the received packet 400 or preamble 401 has been transmitted to the first communication node. According to a result of the determination, the first communication node may maintain the down-clocking state, or may transition to a full-clocking state. Here, the full-clocking state may mean a state in which the first communication node operates at a clock state or a clock speed before operating in the down-clocking state. For example, when it is determined that the received packet 400 or preamble 401 has not been transmitted to the first communication node, the first communication node may maintain the down-clocking state. On the other hand, when it is determined that the received packet 400 or preamble 401 has been transmitted to the first communication node, the first communication node may transition to the full-clocking state.

Referring to FIG. 4B, the first communication node may perform monitoring in the down-clocking state during the idle listening period 410. The first communication node may detect that a first packet transmitted from the second communication node arrives at a time 420. This may be referred to as a ‘packet arrival detection (PAD)’ operation.

At a time 430 after the time 420, the first communication node may identify information on an address included in the first packet. This may be referred to as a ‘device address recognition (DAR)’ operation. Specifically, the first communication node may identify a destination address or a terminal address corresponding to the first packet included in a preamble of the first packet. If the identified address corresponds to the first communication node, the first communication node may determine that the first packet has been transmitted to the first communication node. The first communication node may transition to the full-clocking state at a time 440 after the time 430. The first communication node may receive a payload or data portion of the first packet in the full-clock state at a time 450 after the time 440, thereby obtaining the data that the second communication node has transmitted to the first communication node. The first communication node may perform idle listening or monitoring in the down-clocking state again at a time 460 after the time 450 of receiving the data from the second communication node.

After the first communication node detects the arrival of the first packet (i.e., arrival of the preamble of the first packet) at the time 420, there may be a predetermined time interval until it starts receiving the data at the time 450. As described with reference to FIG. 4A, in an exemplary embodiment of the communication system, there may be the predetermined time interval 402 in the time domain between the data and the preamble of the packet. Alternatively, the preamble of the packet may include the padding region 402 corresponding to the predetermined time interval. When the predetermined time interval or padding region 402 is collectively referred to as a ‘first time interval’, the first time interval may have a size greater than or equal to a time interval expected to be required for the first communication node to perform operations such as the DAR operation and/or transition to the full-clocking state before starting receiving the data after detecting the arrival of the first packet. For example, the size of the padding region in the time domain may be configured to be greater than or equal to the size of the time 440 corresponding to a period before the data reception starts. Alternatively, the size of the padding region in the time domain may be configured to be greater than or equal to the size of the times 430 and 440 corresponding to a period after the packet arrival detection and before the data reception starts.

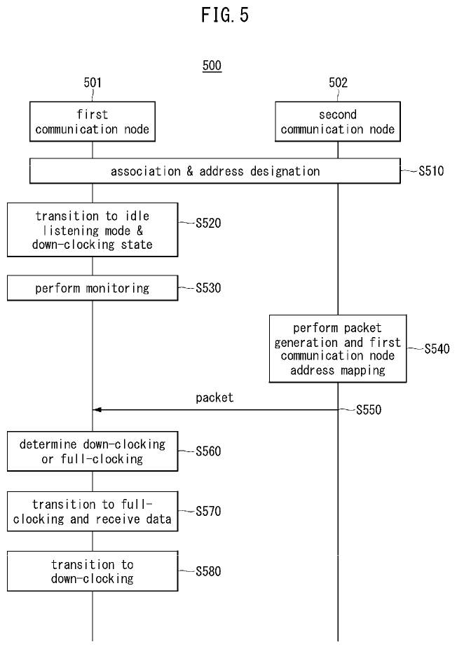

FIG. 5 is a sequence chart illustrating an exemplary embodiment of a signal transmission and reception method in a communication system.

Referring to FIG. 5, a communication system 500 may include a first communication node 501 and a second communication node 502. Here, the first communication node may be the same as or similar to the first communication node described with reference to FIGS. 4A and 4B. The second communication node 502 may be the same as or similar to the second communication node described with reference to FIGS. 4A and 4B. Hereinafter, in describing an exemplary embodiment of a signal transmission and reception method with reference to FIG. 5, content overlapping with those described with reference to FIGS. 1 to 4B may be omitted.

The first communication node 501 and the second communication node 502 may be connected to each other by performing a predetermined association procedure (S510). In the step S510, designation of an address for the first communication node 501 may be performed. For example, the second communication node 502 may designate a first address corresponding to the first communication node 501 in the step S510. The second communication node 502 may transmit information of the first address to the first communication node 501. The second communication node 502 may store information of the first address in an address table.

At a specific time after the association procedure according to the step S510, the first communication node 501 may enter the idle listening mode (S520). Here, the first communication node 501 may transition to the down-clocking state when entering the idle listening mode. The first communication node 501 may monitor a communication environment in the down-clocking state (S530). For example, the first communication node 501 may perform ‘carrier sensing’ for continuously sensing a carrier.

On the other hand, when there is first data to be transmitted to the first communication node 501, the second communication node 502 may generate a first packet including first data (S540). In the first packet generation operation according to the step S540, the second communication node 502 may configure the first packet to include the first data and a first preamble. A structure of the first packet may be the same as or similar to that of the packet 400 described with reference to FIG. 4A.

In the step S540, the second communication node 502 may map the first address as a destination address to the first preamble. Specifically, the second communication node 502 may convert the first address into a binary value. The second communication node 502 may map the converted first address to subcarriers constituting an OFDM symbol. The second communication node 502 may configure the respective subcarriers based on information of the first address having a form of a binary value (i.e., expressed using 0 and 1). For example, the second communication node 502 may map values of 0 and 1 constituting the information of the first address to at least some of the subcarriers according to a predetermined order. The second communication node 502 may configure an energy level to be 0 in case of a subcarrier to which a value of 0 is mapped among the subcarriers. In other words, the second communication node 502 may reflect the information of the terminal address to be mapped to the OFDM symbol to the energy levels of the respective subcarriers constituting the OFDM symbol.

The second communication node 502 may duplicate the OFDM symbol to which the first address is mapped into two OFDM symbols. The second communication node 502 may configure the first preamble by concatenating two duplicated identical symbols. Alternatively, the second communication node 502 may configure the first preamble to include two identical symbols concatenated with each other.

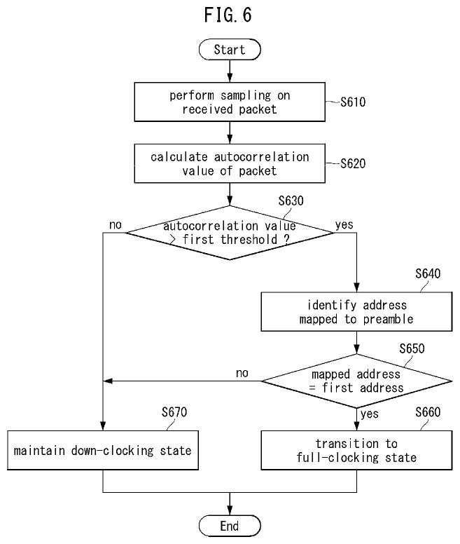

The second communication node 502 may transmit the first packet including the first preamble to which the first address is mapped to the first communication node 501 (S550). The first communication node 501 may receive the first packet transmitted from the second communication node 502 (S550). The first communication node 501 may determine whether to maintain the down-clocking state or to transition to the full-clocking state based on the received first packet (S560). For example, the first communication node 501 may determine whether the received first packet has been transmitted to the first communication node 501. When it is determined that the first packet has been transmitted to the first communication node 501, the first communication node 501 may determine to transition to the full-clocking state (S560). On the other hand, when it is determined that the first packet has not been transmitted to the first communication node 501, the first communication node 501 may determine to maintain the down-clocking state (S560). With respect to specific technical characteristics of the operations according to the step S560, they will be described in more detail with reference to FIG. 6 below.

When it is determined to maintain the down-clocking state in the step S560, the first communication node 501 may perform monitoring while maintaining the down-clocking state without performing the steps S570 and S580. On the other hand, when it is determined in the step S560 to transition to the full-clocking state, the first communication node 501 may transition to the full-clocking state, and the second communication node 502 the data transmitted from the second communication node 502 in in the full-clocking state (S570). When the data reception according to the step S570 is finished, the first communication node 501 may transition to the down-clocking state (S580), and may perform monitoring in the down-clocking state.

FIG. 6 is a flowchart for describing an exemplary embodiment of a method for determining whether to transition to the full-clocking state in a communication system.

Referring to FIG. 6, a communication system may include a first communication node and a second communication node. Here, the first communication node may be the same as or similar to the first communication node 501 described with reference to FIG. 5. The second communication node may be the same as or similar to the second communication node 502 described with reference to FIG. 5. Operations shown in FIG. 6 may be the same as or similar to the operations performed in the step S560 described with reference to FIG. 5. Hereinafter, in describing an exemplary embodiment of a method of determining whether to transition to the full-clocking state in the communication system with reference to FIG. 6, content overlapping with those described with reference to FIGS. 1 to 5 may be omitted.

When the first communication node receives the first packet transmitted from the second communication node through carrier sensing in the down-clocking state, the first communication node may perform sampling on the received first packet (S610). In the step S610, the first communication node may perform sampling on the detected first packet by sensing carrier energy level values of the first packet.

The first communication node may sense the carrier energy level values within each of two time windows. The first communication node may calculate an auto-correlation value between the energy level values sensed in the first time window of the two time windows and the energy level values sensed in the second time window of the two time windows (S620). The first communication node may compare the autocorrelation value calculated in the step S620 with a preset first threshold (S630). If the autocorrelation value calculated in the step S620 is less than or equal to the preset first threshold (S630), the first communication node may determine to maintain the down-clocking state without performing an additional operation based on the first packet (S670).

On the other hand, if the autocorrelation value calculated in the step S620 is greater than the preset first threshold (S630), the first communication node may determine the two time windows for which the autocorrelation value is calculated as the first preamble of the first packet, and may identify a destination address or terminal address mapped to the first preamble of the first packet (S640). Specifically, the first communication node may identify energy levels of subcarriers constituting two identical OFDM symbols constituting the first preamble. Here, the first communication node may identify subcarriers to which the information of the terminal address is determined to be mapped, based on a predetermined order, among the subcarriers constituting the OFDM symbols. The first communication node may identify energy levels of the subcarriers to which the information of the terminal address is determined to be mapped. In case of subcarriers having an energy level of 0 or close to 0, the first communication node may determine that a bit value ‘0’ is mapped. On the other hand, the first communication node may determine that a bit value ‘1’ is mapped to subcarriers to which the bit value ‘0’ is not mapped. When the bit values mapped to the respective subcarriers to which the information of the terminal address is determined to be mapped are identified, the first communication node may identify the value of the terminal address mapped to the first packet based on the identified bit values.

The first communication node may compare the value of the address mapped to the first preamble with the value of the first address, which is the address of the first communication node itself designated by the second communication node (S650). If the value of the address mapped to the first preamble matches the value of the first address, the first communication node may determine that the first packet has been transmitted to the first communication node. If the value of the address mapped to the first preamble matches the value of the first address, the first communication node may determine to transition to the full-clocking state (S660).

On the other hand, if the value of the address mapped to the first preamble does not match the value of the first address, the first communication node may determine that the first packet has not been transmitted to the first communication node. If the value of the address mapped to the first preamble does not match the value of the first address, the first communication node may determine to maintain the down-clocking state (S670).

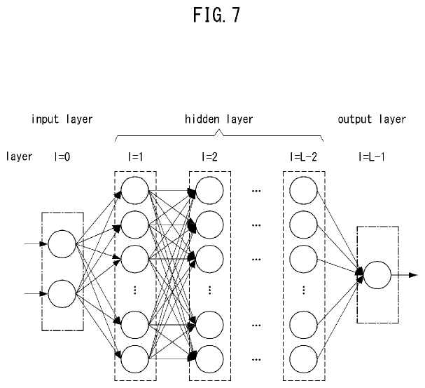

FIG. 7 is a conceptual diagram illustrating a first exemplary embodiment of a machine learning structure used for device address recognition (DAR) in a communication system.

Referring to FIG. 7, a communication system may include a first communication node and a second communication node. Here, the communication system may be the same as or similar to the communication system described with reference to at least one of FIG. 4A, FIG. 4B, and FIG. 6. The first communication node may be the same as or similar to the first communication node described with reference to at least one of FIG. 4A, FIG. 4B, and FIG. 6. The second communication node may be the same as or similar to the second communication node described with reference to at least one of FIG. 4A, FIG. 4B, and FIG. 6. When a packet is received from the second communication node, the first communication node may perform a ‘device address recognition (DAR)’ operation for recognizing a destination address mapped to the packet. Here, the DAR operation may be the same as or similar to the device recognition operation described with reference to FIG. 4B or the operation according to the step S640 described with reference to FIG. 6. Hereinafter, in describing a first exemplary embodiment of a machine learning structure used for the DAR in the communication system with reference to FIG. 7, content overlapping with those described with reference to FIGS. 1 to 6 may be omitted.

It may not be easy for the first communication node to recover OFDM symbols included in the first preamble in the down-clocking state compared to recovering the OFDM symbols in the full-clocking state. In other words, it may not be easy for the first communication node to perform the DAR operation based on the OFDM symbols included in the first preamble in the down-clocking state compared to performing the DAR operation in the full-clocking state.

Meanwhile, in an exemplary embodiment of the communication system, a computational model for performing the DAR operation through machine learning in the first communication node may be constructed. More specifically, the memory and/or storage device of the first communication node may include program instructions for performing machine learning according to a predetermined machine learning structure. Alternatively, the first communication node may include a separate machine learning unit for performing machine learning according to a predetermined machine learning structure.

The first communication node may obtain a computational model for efficiently performing DAR through machine learning according to a structure such as an artificial neural network (ANN) or a deep neural network (DNN). For example, FIG. 7 shows a DNN structure including multiple layers and multiple nodes among the machine learning structures. However, this is only an example for convenience of description, and exemplary embodiments of the present disclosure are not limited thereto. For example, in an exemplary embodiment of the communication system, various machine learning structures such as an ANN structure, a recurrent neural network (RNN) structure, a neuron structure consisting of a single node, a perceptron structure consisting of a single node, a knowledge-based system structure, a structure to which a reasoning technique such as Bayesian is applied, a DNN structure, and/or the like may be applied to the machine learning. A machine learning structure selected according to a predetermined criterion among the various machine learning structures may be applied to the machine learning. For example, a machine learning structure selected according to various conditions such as development and/or production cost, performance requirements, and processor capability of the communication system and/or individual device may be applied to the machine learning.

In an exemplary embodiment of the communication system, a plurality of layers constituting the artificial neural network may include an input layer, at least one hidden layer, an output layer, and the like. The input layer may be a layer to which a data set or data group to be learned is input. The input layer may include at least one or more input nodes. Some or all of entries constituting the data set may be input to the at least one or more input nodes constituting the input layer, respectively. The data set input to at least one or more input nodes constituting the input layer may be data that has undergone data preprocessing in advance. The output layer may refer to a layer in which data or signals input to the artificial neural network are output through operations in the artificial neural network. The output layer may include at least one or more output nodes.

At least one or more hidden layers may be disposed between the input layer and the output layer. An artificial neural network having two or more hidden layers may be referred to as a DNN. That is, among neural network structures including an input layer, hidden layer(s), and an output layer, the DNN may mean a neural network structure in which a plurality of hidden layers are disposed between the input layer and the output layer. A machine learning scheme based on the DNN structure may be referred to as deep learning. The hidden layer may be connected to the input layer, the output layer, or another hidden layer through weight vectors.

In an exemplary embodiment of the communication system, a machine learning apparatus may perform a learning operation of updating the weight vectors of the artificial neural network. Here, the machine learning apparatus may be the first communication node performing the learning operation through the program instructions or the machine learning unit, or an apparatus for perform the learning operation, which exists externally from the first communication node. The machine learning apparatus may include a multi-layer perceptron classifier. The learning operation of the artificial neural network may be performed by the multi-layer perceptron classifier included in the machine learning apparatus. The multi-layer perceptron classifier may train the artificial neural network through a preconfigured learning algorithm. The learning algorithm may include machine learning algorithms such as a supervised learning algorithm and a non-supervised learning algorithm.

In an exemplary embodiment of the communication system, the machine learning apparatus may perform a series of operations through feed-forward operations in the artificial neural network structure and obtain an output value. The machine learning apparatus may obtain error information based on the output value and a preset reference value. The machine learning apparatus may perform the learning operation of correcting the weight vectors between layers of the artificial neural network by back-propagating the calculated error information. The machine learning apparatus may modify the weight vectors between layers of the artificial neural network through a preconfigured optimization algorithm. For example, the optimization algorithm may include a gradient descent scheme, an alternating gradient descent scheme, a stochastic gradient descent scheme, or an Adam-optimizer algorithm. The machine learning apparatus may repeatedly perform the learning operation by the number of epochs corresponding to the preset number of learnings. As the number of epochs increases, prediction performance or accuracy of the model obtained through the machine learning may be improved. On the other hand, as the number of epochs increases, the amount of computation in the machine learning process may increase, the computation load may increase, and the learning efficiency may decrease. The number of epochs may be set to a value that a person skilled in the art determines is appropriate to improve the performance of the machine learning apparatus.

In an exemplary embodiment of the communication system, the first communication node may perform machine learning based on a predetermined neural network structure for the DAR operation. Here, the total number of layers of the neural network structure may be L, and L may be a natural number of 3 or more. When the neural network corresponds to a DNN, L may be a natural number of 4 or more. Each layer may be expressed as the l-th layer (i.e., l=0, 1, . . . L−1) from the input layer to the output layer, and among them, the layers from the (l=1)-th layer to the (l=L−2)-th layer may be the hidden layers. For example, the DNN structure may include three hidden layers, and the hidden layers may consist of 32, 64, and 32 hidden nodes, respectively. However, this is only an example for convenience of description, and the present disclosure is not limited thereto, and may encompass various exemplary embodiments of machine learning or artificial neural network technology.

Input data I may be input to the input layer of the neural network structure. Output data I may be output from the output layer by calculating the input data I input to the input layer through successive functions passing through the respective layers. For example, the output data may be as Equation 1

O=f(I,W)=f^{(L-1)}(f^{(L-2)}( . . . f⁽¹⁾(I))) [Equation 1]

Here, W may be at least one weight coefficient or weight parameter set between nodes of each layer. f^{(l)} may be a function configured between the l-th layer and the (l−1)-th layer. For example, f^{(l)} may correspond to a function such as a sigmoid function or a rectified linear unit (ReLu). The sigmoid function may refer to a function used for an operation between layers such as output mapping in the machine learning structure. For example, the sigmoid function may be expressed as Equation 2.

$${f}_{s} ( a ) = \frac{1}{1 + {e}^{- a}} \qquad [ Equation 2 ]$$

The ReLu function may refer to a function used as an activation function in an operation between the layers, such as the input layer and/or the hidden layers. For example, the ReLu function may be expressed as in Equation 3.

fᵣ(a)=max(0,a) [Equation 3]

However, the functions such as Equations 2 and 3 are merely examples presented to enhance understanding, and exemplary embodiments of the present disclosure are not limited thereto, and may encompass various types of neural network exemplary embodiments.

In an exemplary embodiment of the communication system, the neural network structure of the first communication node may receive the input data I to generate a learning model and output the output data O. Here, the operation of generating the learning model may be performed before actually performing data packet transmission/reception with the AP or at a specific point during the data packet transmission/reception with the AP.

The input data I may include information related to a result of receiving the OFDM symbol(s). For example, the input data I may include a plurality of energy levels measured in a plurality of received OFDM symbols. Specifically, each OFDM symbol may have the same or similar structure to that of the OFDM symbol constructed according to the mapping operation described with reference to the step S540 of FIG. 5. Each OFDM symbol may include a plurality of subcarriers. The input data I may include an energy level measurement result for each of the plurality of subcarriers constituting each OFDM symbol.

In the input layer of the neural network structure shown in FIG. 7, the input data I including information on the results of receiving the plurality of (e.g., K) OFDM symbols to which the same terminal address is mapped may be input. The information on the result of receiving one OFDM symbol may be input to one input node of the input layer of the neural network structure. Alternatively, information on the result of receiving a plurality of OFDM symbols may be processed or pre-processed and input to the input layer of the neural network structure. The input data I composed of a plurality of pieces of information may be input in a vector form. The neural network structure may output the output data O by performing, on the input data I input in the vector form, an operation based on the weight coefficients W in a vector form. For example, in some or all of the neural network structure configured through neurons or perceptrons in an exemplary embodiment of the communication system, the output value may be calculated using a sigmoid function as shown in Equation 4.

$$y = \frac{1}{1 + {e}^{- {x}^{T} W}} \qquad [ Equation 4 ]$$

Here, x may be vector data corresponding to information input as the input data I. For example, x may be vector data composed of information on the reception results of the OFDM symbols. Alternatively, x may be vector data composed of values obtained by processing or scaling information on the reception result of each of the OFDM symbols to a value between 0 and 1. W may correspond to at least one weight coefficient configured in a vector form. y may correspond to a value obtained as a result of the operation or output data O. The output data O may correspond to an estimated value (i.e., estimated device address) of a device address (or terminal address) to be obtained through the DAR operation. That is, the neural network structure may receive information on the OFDM symbol reception results and output an estimated device address value.

In the machine learning scheme through the artificial neural network having a structure such as a DNN, the output value may be evaluated according to a regression learning model, and the respective parameters may be updated. For the evaluation of the output value, a loss function may be defined based on a relationship between the output value and an correct answer value. For example, in an exemplary embodiment of the artificial neural network, the loss function may be defined as in Equation 5.

$$Loss = \frac{1}{K} {\sum }_{k = 1}^{K} {( a - \hat{a} )}^{2} \qquad [ Equation 5 ]$$

Here, K may mean the number of training samples. a may correspond to a correct answer value or an answer vector to be learned through the artificial neural network, and â may correspond to the output value or output vector output through the output layer of the artificial neural network. However, the loss function of Equation 4 is only an example for enhancing understanding, and exemplary embodiments of the present disclosure are not limited thereto, and may encompass various types of loss function exemplary embodiments.

The loss function may have a smaller value as a difference between the output value ä and the correct answer value a is smaller. In an exemplary embodiment of the machine learning, iterative learning and parameter update may be performed in a direction in which the loss function is minimized. Accordingly, the output value â output through the artificial neural network structure may approach the correct answer value a. That is, the computational performance or predictive performance of the computational model or the predictive model obtained through the artificial neural network structure may be improved. For example, in the learning process for generating the computational model for DAR in the first communication node, the neural network structure may receive information related to the reception results of OFDM symbols and output the estimated device address value. Here, comparison between the estimated device address corresponding to the output value and the device address value included in the actual OFDM symbols corresponding to the correct answer may be performed. Accordingly, the iterative learning and parameter update may be performed in a direction in which the loss function defined based on the output value and the correct answer value is minimized.

The machine learning apparatus may repeatedly perform the learning operation by the number of epochs corresponding to the preset number of learning. For the iterative learning operation, OFDM symbols to which the same device address values are mapped may be used, or OFDM symbols to which different device address values are mapped may be used. For example, OFDM symbols to which the m-th device address value is mapped may be used in the m-th learning, and OFDM symbols to which the (m+1)-th device address value is mapped may be used in the (m+1)-th learning. Here, the m-th device address value and the (m+1)-th device address value may be the same as or different from each other.

As the learning operation is iteratively performed, a predictive model, which uses the reception results of the OFDM symbols as the input value and uses the estimated device address value as the output value, may be generated. The first communication node may perform the DAR operation on a packet received from the second communication node based on the predictive model generated through iterative learning. Specifically, the first communication node may input information on energy levels measured for subcarriers of the OFDM symbols included in the packet received from the second communication to the prediction model generated through the same or similar iterative learning as described with reference to FIG. 7, and obtain an estimated value of a device address (i.e., terminal address) mapped to the packet from the predictive model. Through this, the performance of the DAR operation of the first communication node may be improved.

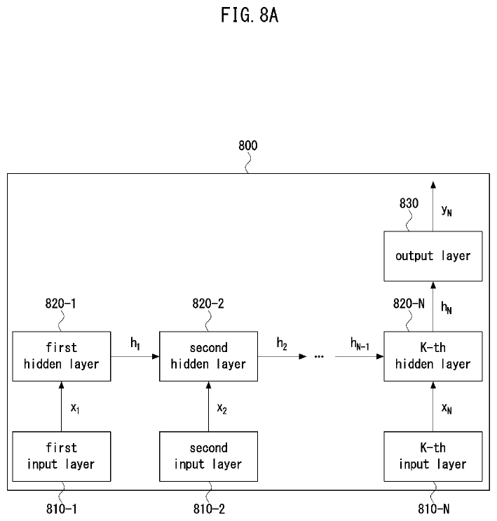

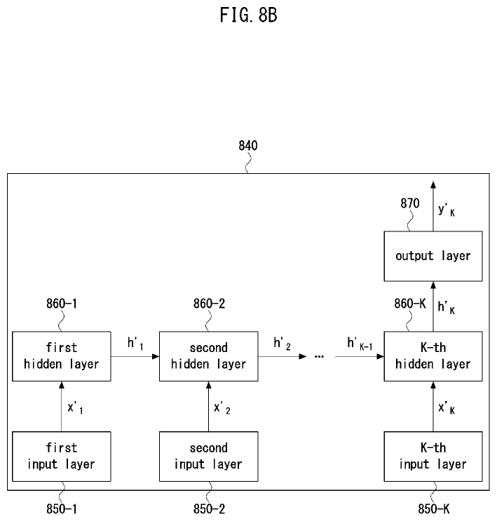

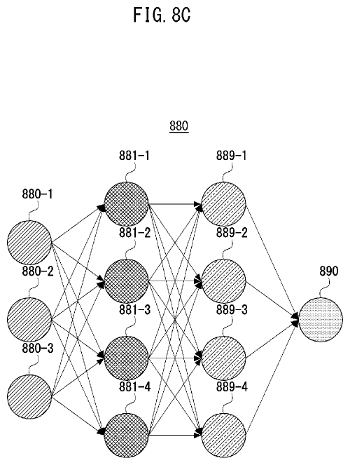

FIGS. 8A to 8C are conceptual diagrams for describing a second exemplary embodiment of a machine learning structure used for DAR in a communication system.

Referring to FIGS. 8A to 8C, a communication system may include a first communication node and a second communication node. Here, the communication system may be the same as or similar to the communication system described with reference to at least one of FIG. 4A, FIG. 4B, and FIG. 6. The first communication node may be the same as or similar to the first communication node described with reference to at least one of FIG. 4A, FIG. 4B, and FIG. 6. The second communication node may be the same as or similar to the second communication node described with reference to at least one of FIG. 4A, FIG. 4B, and FIG. 6. When a packet is received from the second communication node, the first communication node may perform a DAR operation for recognizing a destination address mapped to the packet. Here, the DAR operation may be the same as or similar to the device recognition operation described with reference to FIG. 4B or the operation according to the step S640 described with reference to FIG. 6. Hereinafter, in describing a first exemplary embodiment of a machine learning structure used for the DAR in the communication system with reference to FIGS. 8A to 8C, content overlapping with those described with reference to FIGS. 1 to 7 may be omitted.

In an exemplary embodiment of the communication system, a computational model for performing the DAR operation through machine learning in the first communication node may be constructed. More specifically, the memory and/or storage device of the first communication node may include program instructions for performing machine learning according to a predetermined machine learning structure. Alternatively, the first communication node may include a separate machine learning unit for performing machine learning according to a predetermined machine learning structure. The first communication node may obtain a computational model for efficiently performing DAR through machine learning according to a structure such as the RNN. The RNN operation may be performed based on a first artificial neural network 800 shown in FIG. 8A, a second artificial neural network 840 shown in FIG. 8B, and a third artificial neural network 880 shown in FIG. 8C. The artificial neural network having the RNN structure may have an advantage in that prediction performance for time series data is high. The machine learning according to the machine learning structure including the RNN structure may be referred to as ‘learning according to the RNN scheme’.

Referring to FIG. 8A, the first artificial neural network 800 may include N input layers 810-1 to 810-N, N hidden layers 820-1 to 820-N, and an output layer 830. The first input layer 810-1 may be connected to the first hidden layer 820-1. The second input layer 810-2 may be connected to the second hidden layer 820-2. The N-th input layer 810-N may be connected to the N-th hidden layer 820-N. Also, the N-th hidden layer 820-N may be connected to the output layer 830.

The first input layer 810-1 may receive first input data that is a part of a first input data group. The first input layer 810-1 may generate a first matrix X₁ by processing the first input data. The first input layer 810-1 may deliver the first matrix X₁ to the first hidden layer 820-1. The first hidden layer 820-1 may receive the first matrix X₁ from the first input layer 810-1. The first hidden layer 820-1 may generate a first hidden matrix h₁ based on the first matrix X₁. The first hidden layer 820-1 may deliver the first hidden matrix h₁ to the second hidden layer 820-2.

The second input layer 810-2 may receive second input data that is a part of the first input data group. The second input layer 810-2 may generate a second matrix X₂ by processing the second input data. The second input layer 810-2 may deliver the second matrix X₂ to the second hidden layer 820-2. The second hidden layer 820-2 may receive the second matrix X₂ from the second input layer 810-2. In addition, the second hidden layer 820-2 may receive the first hidden matrix h₁ from the first hidden layer 820-1. The second hidden layer 820-2 may generate a second hidden matrix h₂ based on Equation 6 below.

hₜ=f(UXₜ+Whₜ₋₁) [Equation 6]

In Equation 6, hₜ may be a t-th hidden matrix, f may be a loss function, U may be a first weight, Xₜ may be a t-th matrix, W may be a second weight, and hₜ₋₁ may be a (t−1)-th hidden matrix. f may be any one of a ReLu function, a sigmoid function, or a tan h function, but this is only an example for convenience of description, and exemplary embodiments of the present disclosure are not limited thereto. When the second hidden layer 820-2 generates the second hidden matrix h₂, t may be 2. In addition, the first weight may be a weight between the input layer (e.g., the first input layer 810-1) and the hidden layer (e.g., the first hidden layer 820-1), and the second weight may be a weight between the hidden layers (e.g., the first hidden layer 820-1 and the second hidden layer 820-2). The second hidden layer 820-2 may deliver the second hidden matrix h₂ to the third hidden layer.

If the above process is repeated, N-th input data that is a part of the first input data group may be input to the N-th input layer 810-N. The N-th input layer 810-N may generate an N-th matrix X_{N} by processing the N-th input data. The N-th input layer 810-N may deliver the N-th matrix X_{N} to the N-th hidden layer 820-N.

The N-th hidden layer 820-N may receive the N-th matrix X_{N} from the N-th input layer 810-N. Also, the N-th hidden layer 820-N may receive the (N−1)-th hidden matrix h_{N-1} from the (N−1)-th hidden layer. The N-th hidden layer 820-N may generate an N-th hidden matrix h_{N} based on the N-th matrix X_{N} and the (N−1)-th hidden matrix h_{N-1}. The N-th hidden layer 820-N may generate the N-th hidden matrix h_{N} based on Equation 6. The N-th hidden layer 820-N may deliver the N-th hidden matrix h_{N} to the output layer 830. The output layer 830 may receive the N-th hidden matrix h_{N} from the N-th hidden layer 820-N.

The output layer 830 may generate the first output data y_{N} based on the N-th hidden matrix h_{N}. The output layer 830 may generate first output data y_{H} having a first size. Here, the output layer 830 may generate the first output data y_{N} based on Equation 7 below.

y_{N}=f(Vhₜ) [Equation 7]

In Equation 7, f may be a loss function. For example, f may be the same as or similar to the loss function expressed in Equation 5, but this is only an example for convenience of description, and exemplary embodiments of the present disclosure are not limited thereto. V may be a matrix for adjusting the size of the t-th hidden matrix hₜ. When the t-th hidden matrix hₜ is the N-th hidden matrix h_{N}, Yₜ may be Y_{N}. The output layer 830 may output the first output data Y_{N}.

Referring to FIG. 8B, the second artificial neural network 850 may include K input layers 850-1 to 850-K, K hidden layers 860-1 to 860-K, and an output layer 870. The first input layer 850-1 may be connected to the first hidden layer 860-1. The second input layer 850-2 may be connected to the second hidden layer 860-2, and the K-th input layer 850-K may be connected to the K-th hidden layer 860-K. Also, the K-th hidden layer 860-K may be connected to the output layer 870.

The first input layer 850-1 may receive first input data that is a part of the second input data group. The first input layer 850-1 may generate a first vector x₁′ by processing the first input data. The first input layer 850-1 may deliver the first vector x₁′ to the first hidden layer 860-1.

The first hidden layer 860-1 may receive the first vector x₁′ from the first input layer 850-1. The first hidden layer 860-1 may generate a first hidden vector h₁′ based on the first vector x₁′. The first hidden layer 860-1 may deliver the first hidden vector h₁′ to the second hidden layer 860-2.

The second input layer 860-1 may receive second input data that is a part of the second input data group. The second input layer 850-2 may generate a second matrix X′₂ by processing the second input data. The second input layer 850-2 may deliver the second matrix X′₂ to the second hidden layer 860-2.

The second hidden layer 860-2 may receive the second input matrix X′₂ from the second input layer 850-2. Also, the second hidden layer 860-2 may receive the first hidden matrix h′₁ from the first hidden layer 860-1. The second hidden layer 860-2 may generate a second hidden matrix h′₂ based on the second matrix X′₂ and the first hidden matrix h′₁. The second hidden layer 860-2 may generate the second hidden matrix h′₂ according to Equation 6. In this case, U in Equation 6 may be U′, Xₜ may be X′ₜ, W may be W′, and hₜ₋₁ may be h′ₜ₋₁. The second hidden layer 860-2 may deliver the second hidden matrix h′₂ to the third hidden layer.

In the above-described manner, the K-th input layer 850-K may receive K-th input data that is a part of the second input data group. The K-th input layer 850-K may generate a K-th matrix X′_{K} by processing the K-th input data. The K-th input layer 850-K may deliver the K-th matrix X′_{K} to the K-th hidden layer 860-K.

The K-th hidden layer 860-K may receive the K-th matrix X′_{K} from the K-th input layer 850-K, and receive the (K−1)-th hidden matrix from the (K−1)-th hidden layer. The K-th hidden layer 860-K may generate a K-th hidden matrix h′_{K} based on the K-th matrix X′_{K} and the (K−1)-th hidden matrix h′_{K-1}. The K-th hidden layer 860-K may generate the K-th hidden matrix h′_{K} based on Equation 6. The K-th hidden layer 860-K may deliver the K-th hidden matrix h′_{K} to the output layer 870.

The output layer 870 may receive the K-th hidden matrix h′_{K} from the K-th hidden layer 860-K. The output layer 870 may generate second output data y′_{K} based on the K-th hidden matrix h′_{K}. The output layer 870 may generate the second output data y′_{K} having a second size. The output layer 870 may generate the second output data y′_{K} based on Equation 7. In this case, yₜ in Equation 7 may be y′ₜ, V may be V′, hₜ may be h′ₜ, and t may be K. The output layer 870 may output the second output data y′_{K}.

Referring to FIG. 8C, the third artificial neural network 880 may be configured to be the same as or similar to the neural network described with reference to FIG. 7. The third artificial neural network 880 may include input layers 880-1 to 880-3, first hidden layers 881-1 to 881-4, second hidden layers 889-1 to 889-4, and an output layer 890. FIG. 8 shows an exemplary embodiment including in which the third artificial neural network 880 includes the three input layers 880-1 to 880-3, the four first hidden layers 881-1 to 881-4, the four second hidden layers 889-1 to 889-4, and the output layer 890. However, this is only an example for convenience of description, and exemplary embodiments of the present disclosure are not limited thereto.

Each of the input layers 880-1 to 880-3 may be fully-connected to all of the first hidden layers 881-1 to 881-4 through a plurality of artificial nodes. Each of the first hidden layers 881-1 to 881-4 may be fully-connected to all of the second hidden layers 889-1 to 889-4 through a plurality of artificial nodes. Also, all of the second hidden layers 889-1 to 889-4 may be connected to the output layer 890 through a plurality of artificial nodes.

Third input data generated based on the first output data and the second output data may be input to the input layers 880-1 to 880-3. The third output data generated by the third artificial neural network 800 based on the third input data may be expressed as in Equation 8 below.

yₜ″=W″*xₜ″+n [Equation 8]

In Equation 8, yₜ″ may be the third output data, W″ may be a weight, xₜ″ may be the third input data, and n may be a Gaussian noise.

Input data input to the input layers 810-1 to 810-N and 820-1 to 820-K of the first artificial neural network 800 and the second artificial neural network 840 may include information related to the results of receiving the OFDM symbols. For example, the input data input to the input layers 810-1 to 810-N of the first artificial neural network 800 may include information on energy levels of subcarriers measured in each of N OFDM symbols to which the same device address value is mapped. The input data input to the input layers 820-1 to 820-K of the second artificial neural network 840 may include information on energy levels of subcarriers measured in each of the K OFDM symbols to which the same device address value is mapped. The value output from the output layer 890 of the third artificial neural network 880 through the operations in the first to third artificial neural networks 800, 830, and 880 may correspond to an estimated value of the device address mapped to the OFDM symbol. The first to third artificial neural networks 800, 830, and 880 may be updated based on comparison between the estimated device address output from the output layer 890 and an actual device address value that is a correct answer. For example, iterative learning and parameter update may be performed in a direction in which a predetermined loss function defined based on the estimated value of the device address output from the output layer 890 and the actual device address value that is a correct value is minimized.

The machine learning apparatus may repeatedly perform the learning operation using the first to third artificial neural networks 800, 830, and 880. As the learning operation is iteratively performed, a predictive model may be generated using the results of receiving the OFDM symbols as the input values and the estimated value of the device address as the output value. The first communication node may perform a DAP operation on a packet received from the second communication node based on the predictive model generated through iterative learning. Specifically, the first communication may input information of energy levels of subcarriers measured for the OFDM symbols included in the preamble of the packet received from the second communication node to the prediction model generated through the same or similar iterative learning as described with reference to FIG. 8, and may obtain an estimated value of the device address (i.e., terminal address) mapped to the packet from the predictive model. Through this, the performance of the DAR operation of the first communication node may be improved.

The machine learning described with reference to FIG. 7 or the machine learning described with reference to FIGS. 8A to 8C may be performed in the down-clocking state. Alternatively, the machine learning described with reference to FIG. 7 or the machine learning described with reference to FIGS. 8A to 8C may be performed in the full-clocking state.

As the correct value used in the machine learning described with reference to FIG. 7 or the machine learning described with reference to FIGS. 8A to 8C, the device address value obtained through a result of restoring the OFDM symbols transmitted from the second communication node may be used. Alternatively, the second communication node may provide information of the actual device address value mapped to each OFDM symbol, which corresponds to the correct value for the machine learning, to the first communication node through a separate path.

According to an exemplary embodiment of the present disclosure, in a power saving mode, a terminal using a wireless LAN may perform monitoring in a down-clocking state during an idle listening time. Accordingly, power consumption occurring while the terminal performs monitoring during the idle listening time can be reduced. An AP may configure a packet to be transmitted to the terminal based on predetermined orthogonal frequency division multiplexing (OFDM) symbols to which an address of the terminal is mapped. The terminal may determine whether to maintain the down-clocking state or transition to a full-clocking state based on the OFDM symbols transmitted from the AP. Accordingly, the power consumption of the terminal using the wireless LAN can be reduced, and a network throughput can be improved.

A clock rate in the down-clocking state according to the present disclosure may be set to a value lower than a clock rate in the full-clocking state. For example, when the clock rate in the full-clocking state is assumed to be 1, the clock rate in the down-clocking state may correspond to ½ or ¼. However, this is only an example for convenience of description, and exemplary embodiments of the present disclosure are not limited thereto.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first communication node in a communication system, the operation method comprising:
transitioning to a down-clocking state;
performing a monitoring operation in the down-clocking state;
detecting reception of a first packet transmitted from a second communication node providing a service to the first communication node;
identifying a first preamble included in the first packet;
performing analysis on the first preamble; and
based on a result of the analysis on the first preamble, determining whether to maintain the down-clocking state or transition to a full-clocking state.

2. The operation method according to claim 1, wherein the first preamble has a structure including two identical orthogonal frequency division multiplexing (OFDM) symbols each of which is mapped to address information corresponding to the first communication node.

3. The operation method according to claim 2, wherein the monitoring operation corresponds to a carrier sensing operation, and the performing of the analysis comprises:
detecting carrier energy level values of the first preamble including the two identical OFDM symbols in each of two separate time windows;
calculating an auto-correlation value between energy level values detected in the two separate time windows;
comparing the calculated autocorrelation value with a first threshold; and
in response to determining that the calculated autocorrelation value is greater than the first threshold, determining to perform device address recognition (DAR) for the first preamble.

4. The operation method according to claim 2, wherein the monitoring operation corresponds to a carrier sensing operation, and the performing of the analysis comprises:
detecting carrier energy level values of the first preamble including the two identical OFDM symbols in each of two separate time windows;
calculating an auto-correlation value between energy level values detected in the two separate time windows;
comparing the calculated autocorrelation value with a first threshold; and
in response to determining that the calculated autocorrelation value is less than or equal to the first threshold, determining to maintain the down-clocking state.

5. The operation method according to claim 1, wherein the performing of the analysis on the first preamble comprises:
obtaining a device address value mapped to the first preamble through device address recognition for the first preamble; and
comparing the obtained device address value with a first address value that is an address of the first communication node.

6. The operation method according to claim 5, wherein the obtaining of the device address value mapped to the first preamble comprises:
identifying energy levels of a plurality of subcarriers constituting one or more OFDM symbols constituting the first preamble; and
identifying information on the device address value based on the identified energy levels of the plurality of subcarriers.

7. The operation method according to claim 5, wherein the determining whether to maintain the down-clocking state or transition to the full-clocking state comprises:
in response to determining that the obtained device address value does not match the first address value, determining to maintain the down-clocking state.

8. The operation method according to claim 5, wherein the determining whether to maintain the down-clocking state or transition to the full-clocking state comprises:
in response to determining that the obtained device address value matches the first address value, determining to transition to the full-locking state.

9. The operation method according to claim 8, further comprising, after determining to transition to the full-clocking state,
receiving data included in the first packet transmitted from the second communication node in the full-clocking state; and
when the reception of the data included in the first packet is completed, transitioning to the down-clocking state.

10. The operation method according to claim 1, further comprising, before transitioning to the down-clocking state,
performing iterative learning a plurality of times based on results of receiving a plurality of OFDM symbols transmitted from the second communication node, through a predetermined machine learning structure; and
generating a first computational model, the first computational mode using the results of receiving the plurality of OFDM symbols as input values and using an estimated value of a device address mapped to the plurality of OFDM symbols as an output value.

11. The operation method according to claim 10, wherein the predetermined machine learning structure includes a deep neural network (DNN) configured to include a plurality of hidden layers, and the iterative learning is performed based on a DNN scheme.

12. The operation method according to claim 10, wherein the predetermined machine learning structure includes a first artificial neural network, a second artificial neural network, and a third artificial neural network, and the iterative learning is performed based on a recurrent neural network (RNN) scheme.

13. The operation method according to claim 10, wherein the performing of the analysis on the first preamble comprises obtaining a device address value mapped to the first preamble through device address recognition for the first preamble, and the obtaining of the device address value mapped to the first preamble is performed based on the first computational model.

14. A first communication node in a communication system, the first communication node comprising:
a processor;
a memory electronically communicating with the processor; and
instructions stored in the memory,
wherein when executed by the processor, the instructions cause the first communication node to:
transition to a down-clocking state;
perform a monitoring operation in the down-clocking state;
detect reception of a first packet transmitted from a second communication node providing a service to the first communication node;
identify a first preamble included in the first packet;
perform analysis on the first preamble; and
based on a result of the analysis on the first preamble, determine whether to maintain the down-clocking state or transition to a full-clocking state.

15. The first communication node according to claim 14, wherein the first preamble has a structure including two identical orthogonal frequency division multiplexing (OFDM) symbols each of which is mapped to address information corresponding to the first communication node, the monitoring operation corresponds to a carrier sensing operation, and the instructions further cause the first communication node to:
detect carrier energy level values of the first preamble including the two identical OFDM symbols in each of two separate time windows;
calculate an auto-correlation value between energy level values detected in the two separate time windows;
compare the calculated autocorrelation value with a first threshold;
in response to determining that the calculated autocorrelation value is greater than the first threshold, determine to perform device address recognition (DAR) for the first preamble; and
in response to determining that the calculated autocorrelation value is less than or equal to the first threshold, determine to maintain the down-clocking state.

16. The first communication node according to claim 14, wherein the instructions further cause the first communication node to:
obtain a device address value mapped to the first preamble through device address recognition for the first preamble; and
compare he obtained device address value with a first address value that is an address of the first communication node.

17. The first communication node according to claim 16, wherein the instructions further cause the first communication node to:
identify energy levels of a plurality of subcarriers constituting one or more OFDM symbols constituting the first preamble; and
identify information on the device address value based on the identified energy levels of the plurality of subcarriers.

18. The first communication node according to claim 16, wherein the instructions further cause the first communication node to:
in response to determining that the obtained device address value does not match the first address value, determine to maintain the down-clocking state; and
in response to determining that the obtained device address value matches the first address value, determine to transition to the full-locking state.

19. The first communication node according to claim 14, wherein the instructions further cause the first communication node to, before transitioning to the down-clocking state,
perform iterative learning a plurality of times based on results of receiving a plurality of OFDM symbols transmitted from the second communication node, through a predetermined machine learning structure; and
generate a first computational model, the first computational mode using the results of receiving the plurality of OFDM symbols as input values and using an estimated value of a device address mapped to the plurality of OFDM symbols as an output value.

20. The first communication node according to claim 19, wherein the predetermined machine learning structure includes a first artificial neural network, a second artificial neural network, and a third artificial neural network, the iterative learning is performed based on a recurrent neural network (RNN) scheme, and the instructions further cause the first communication node to perform device address recognition for the first preamble based on the first computational model.
